(19) United States
(12) Patent Application Publication
(10) Pub. No.: US 2016/0300173 A1
(43) Pub. Date: Oct. 13, 2016

(54) OSCILLATION DETECTION AND REDUCTION IN SUPPLY CHAIN

(71) Applicant: Caterpillar Inc., Peoria, IL (US)

(72) Inventor: Anthony James GRICHNIK, Eureka, IL (US)

(73) Assignee: CATERPILLAR INC., Peoria, IL (US)

(21) Appl. No.: 14/684,229

(22) Filed: Apr. 10, 2015

(51) Int. Cl. G06Q 10/06; G06Q 10/08

(52) U.S. Cl. CPC G06Q 10/06315; G06Q 10/087

(57) ABSTRACT

A system is disclosed for reducing oscillation in a supply chain, including a memory configured to store instructions, one or more input/output devices configured to receive user inputs and generate a user interface, and a processor configured to receive and execute the instructions. The instructions cause the processor to determine a plurality of network parameters for the supply chain for supplying a plurality of product lines from a plurality of sources to a plurality of customers. The instructions further cause the processor to transform the network parameters from a real space to a neutral space according to a common basis, and determine a neutral-space optimized network model for the supply chain based on neutral-space representations of the network parameters. The instructions further cause the processor to determine real-space supply-demand relationships based on the neutral-space optimized network model, and configure supply chain based on the real-space supply-demand relationships.

### TECHNICAL FIELD

This disclosure relates generally to supply chain network optimization, and more particularly, to a system and method for detecting and reducing oscillations in supply chains.

### BACKGROUND

Supply chain planning may be essential to the success of many of today's companies. Most companies may rely on supply chain planning to ensure the timely and reliable delivery of products in response to customer demands. In supply chain network optimization, the network structure is often adjusted, in consideration of estimated customer demands, so as to maximize the profit of a business.

For example, U.S. Pat. No. 7,080,026 B2, to Singh et al. (“the '026 patent”) discloses a method for supply chain demand forecasting. The method enables users to compare statistical algorithms paired with various historical models so as to run various simulations and evaluate which model will provide the best forecast for a particular product in a given market. The forecasts may take into account level, trend, seasonal effects, and casual factors.

Most conventional supply chain network optimization techniques only consider variations in demand data, but fail to address variations at production sources that supply the products. For those existing techniques that consider the supply-side variations, they fail to effectively model the interactions between multiple different product lines that are simultaneously supplied by the supply chain. As a result, the resulting configurations of the supply chain are often unstable.

For example, when the total network demand for a product changes, a supply chain configured by conventional techniques may produce oscillation. The term “oscillation” here refers to unexpected variations in the flow of physical goods and services from a source (i.e., a manufacturing facility) to a destination (i.e., a customer) even if there is a mere slight variation in the total network demand. When such variation occurs, the network structure of the supply chain unexpectedly changes. Ideally, oscillation should not occur when the total network demand is significantly below the total network capacity, because the supply chain should have sufficient capacity to meet the total network demand to provide stable and consistent performance. However, existing supply chain optimization techniques may result in a supply chain that oscillates even when the total network demand is far below the total network capacity. In severe cases, a supply chain could oscillate when the total network demand is only 10% of the total network capacity.

Existing supply chain planning techniques attempt to reduce oscillation by managing or changing customer demands. For example, the business entity that operates a supply chain may change pricing strategies when oscillation occurs, so as to reduce customer demands within a particular time period or shift the customer demands to a different time period. Alternatively, the business entity may also choose to back order the product when the supply chain is under stress. These measures, however, may adversely affect the profits of the business and the customer relationship, thereby causing significant uncertainties to the business.

The disclosed system and method are directed to improving upon existing technologies used in supply chain network planning.

### SUMMARY

In one aspect, the present disclosure is directed to a system for reducing oscillation in a supply chain including a plurality of supply chain entities. The supply chain entities include a plurality of sources and a plurality of customers. The system includes a memory configured to store instructions, one or more input/output devices configured to receive user inputs and generate a user interface, and a processor configured to receive and execute the instructions. The instructions cause the processor to determine a plurality of network parameters for the supply chain for supplying a plurality of product lines from the plurality of sources to the plurality of customers. The instructions further cause the processor to transform the network parameters from a real space to a neutral space according to a common basis, and determine a neutral-space optimized network model for the supply chain based on neutral-space representations of the network parameters. The instructions further cause the processor to determine real-space supply-demand relationships based on the neutral-space optimized network model, and configure the supply chain based on the real-space supply-demand relationships.

In another aspect, the present disclosure is directed to a method for reducing oscillation in a supply chain including a plurality of supply chain entities. The supply chain entities include a plurality of sources and a plurality of customers. The method comprises determining, by a processor, a plurality of network parameters for the supply chain for supplying a plurality of product lines from the plurality of sources to the plurality of customers. The method further comprises transforming, by the processor, the network parameters from a real space to a neutral space according to a common basis, and determining, by the processor, a neutral-space optimized network model for the supply chain based on neutral-space representations of the network parameters. The method further comprises determining, by the processor, real-space supply-demand relationships based on the neutral-space optimized network model, and configuring, by a processor, the supply chain based on the real-space supply-demand relationships.

In yet another aspect, the present disclosure is directed to a non-transitory computer-readable medium including instructions, which, when executed by one or more processors, cause the one or more processors to perform a method for reducing oscillation in a supply chain including a plurality of supply chain entities, the supply chain entities including a plurality of sources and a plurality of customers. The method comprises determining a plurality of network parameters for the supply chain for supplying a plurality of product lines from the plurality of sources to the plurality of customers, and transforming the network parameters from a real space to a neutral space according to a common basis. The method further comprises determining a neutral-space optimized network model for the supply chain based on neutral-space representations of the network parameters, and determining real-space supply-demand relationships based on the neutral-space optimized network model. The method further comprises configuring the supply chain based on the real-space supply-demand relationships.

### BRIEF DESCRIPTION OF THE DRAWINGS

FIG. 1 is a schematic illustration of an exemplary supply chain in which the supply chain optimization system consistent with the disclosed embodiments may be implemented.

FIG. 2 is a schematic illustration of an exemplary supply chain optimization system consistent with certain disclosed embodiments.

FIG. 3A is a flow chart illustrating an exemplary process for detecting oscillation in a supply chain consistent with a disclosed embodiment.

FIG. 3B is a flow chart illustrating an exemplary process for supply chain optimization, consistent with a disclosed embodiment.

FIG. 4 illustrates an exemplary supply chain network model for the supply chain shown in FIG. 1, consistent with a disclosed embodiment.

FIG. 5 illustrates an exemplary optimized supply chain network model for the supply chain shown in FIG. 1, consistent with a disclosed embodiment.

FIG. 6 illustrates an exemplary optimized supply chain network model for the supply chain shown in FIG. 1, consistent with another disclosed embodiment.

FIG. 7 illustrates an exemplary interface generated by the supply chain optimization system consistent with a disclosed embodiment.

### DETAILED DESCRIPTION

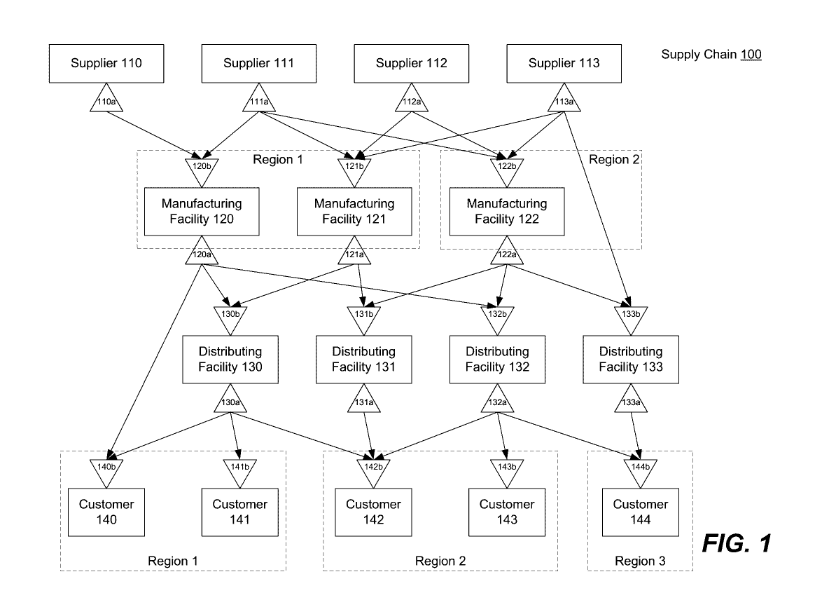

FIG. 1 illustrates an exemplary supply chain 100 in which a supply chain sensitivity analysis system consistent with the disclosed embodiments may be implemented. As shown in FIG. 1, supply chain 100 may include a plurality of supply chain entities, such as suppliers 110-113, manufacturing facilities 120-122, distributing facilities 130-133, and customers 140-144. Supply chain 100 may be used to supply individual items to suppliers 110-113, manufacturing facilities 120-122, distributing facilities 130-133, or customers 140-144. An item, as used herein, may represent any type of physical good that is designed, developed, manufactured, and/or delivered by supply chain 100. Non-limiting examples of the items may include engines, tires, wheels, transmissions, pistons, rods, shafts, or any other suitable component of a product. Alternatively, the term “item” here may also refer to a finished product delivered to a customer. A product, as used herein, may represent any type of finished good that is manufactured, assembled, and delivered to the customers of supply chain 100. Non-limiting examples of products may include chemical products, mechanical products, pharmaceutical products, food, and fixed or mobile machines, such as trucks, cranes, earth moving vehicles, mining vehicles, backhoes, material handling equipment, farming equipment, marine vessels, on-highway vehicles, or any other type of machine that operates in a work environment.

Suppliers 110-113 may supply individual items to one or more of manufacturing facilities 120-122, one or more of distributing facilities 130-133, and one or more of customers 140-144. Manufacturing facilities 120-122 may manufacture or assemble products by using one or more individual items received from suppliers 110-113. The product may include one or more components supplied from suppliers 110-113. The products manufactured by different manufacturing facilities 120-122 may be identical, or may be different from each other. Manufacturing facilities 120-122 may respectively deliver the manufactured products to one or more distributing facilities 130-133, or directly to one or more customers 140-144.

Distributing facilities 130-133 may store individual items received from one or more suppliers 110-113, and may distribute the individual items to customers 140-144 for sale as service or replacement parts for existing products. In addition, distributing facilities 130-133 may store manufactured products received from one or more manufacturing facilities 120-122, and may distribute the manufactured products to customers 140-144. In some embodiments, one of distributing facilities 130-133 may distribute the individual items or manufactured products to another one of distributing facilities 130-133, before the individual items or manufactured products are finally distributed to customers 140-144. A customer may be an end user of the product or a dealer that sells the product to an end user.

Although supply chain 100 shown in FIG. 1 includes four suppliers 110-113, three manufacturing facilities 120-122, four distributing facilities 130-133, and five customers 140-144, those skilled in the art will appreciate that supply chain 100 may include any number of suppliers, manufacturing facilities, distributing facilities, and dealers.

The supply chain entities in supply chain 100 may include upstream supply chain entities, such as suppliers 110-113, and downstream supply chain entities, such as customers 140-144. In supply chain 100, items may flow in a direction from upstream supply chain entities to downstream supply chain entities. Inside each supply chain entity, at least one of a downstream inventory and an upstream inventory may be included. Downstream inventory 110a-113a, 120a-122a, 130a-133a may include inventories of items (e.g., products, parts, or subsystems) that a supply chain entity may need to keep before the items may be accepted by the supply chain entity's downstream supply chain entities. For example, manufacturing facility 120 may include a downstream inventory 120a of products before the items can be transported to and accepted by distributing facility 130.

On the other hand, upstream inventory 120b-122b, 130b-133b, and 140b-144b may include inventories of items (products, parts, or subsystems) that a supply chain entity receives from the supply chain entity's upstream supply chain entities and may need to keep before the items may be used in manufacturing or other transactional processes. In the same example above, manufacturing facility 120 may also include an upstream inventory 120b of engines from supplier 110 before the work machines may be manufactured using the engines and other parts or subsystems. Further, similar to manufacturing facility 120, suppliers 110-113 may respectively include downstream inventories 110a-113a, 120a-122a, 130a-133a; manufacturing facilities 121 and 122 may respectively include downstream inventories 121a and 122a and upstream inventories 121b and 122b; distributing facilities 130-133 may respectively include downstream inventories 130a-133a and upstream inventories 130b-133b; and customers 140-144 may respectively include upstream inventories 140b-144b.

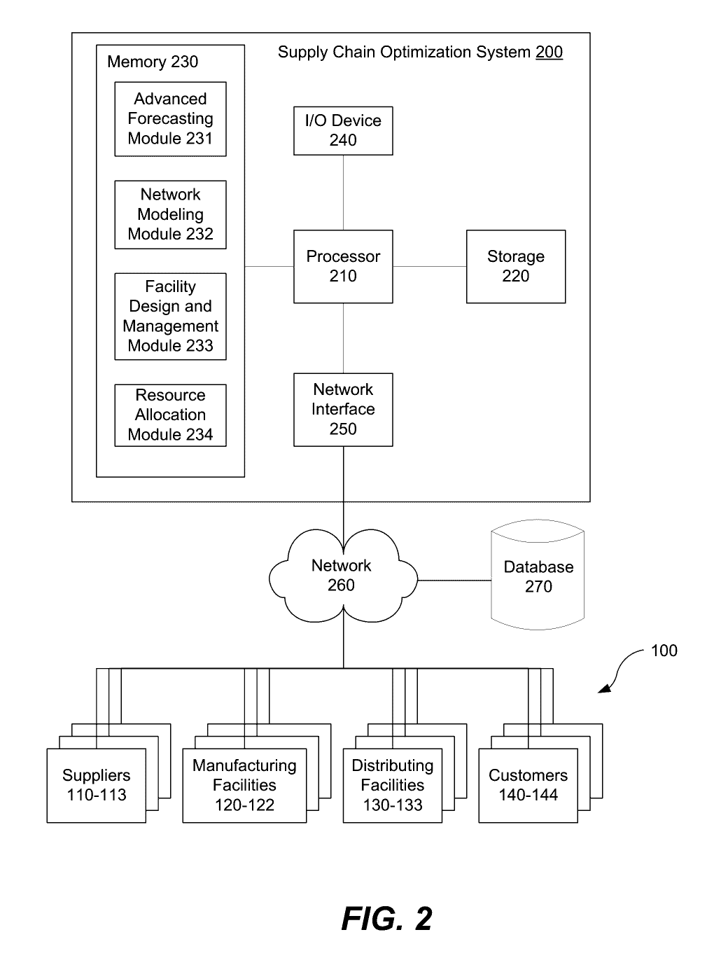

When customers 140-144 make demands to manufacturing facilities 120-122 or distributing facilities 130-133, the structure of the distribution network may be designed to fulfill the demands. The design of the distribution network may be determined according to a plurality of objectives including, for example, minimum inventory cost, maximum profit of the business, time required to fulfill the demands, environmental impact, resilience of the network, total route distance, etc. The determination may be carried out according to disclosed embodiments by an exemplary system as shown in FIG. 2. The system disclosed herein may consider one or more of these objectives simultaneously in determining the structure of the distribution network. The system may use any linear or nonlinear programming techniques known in the art to determine a model or design for supply chain 100 according to the objectives. In some embodiments, the objectives considered by the system may be competing with one another. The system may balance the competing objectives while determining the model for supply chain 100.

It is further noted that each arrowed line in FIG. 1 directed from an upstream entity to a downstream entity represents a transportation path between the associated upstream entity and the associated downstream entity. Each transportation path may be supported by one or more of automobiles, vessels, or planes via land, water, or air. Furthermore, each arrowed line indicates that the associated upstream entity has the capability to deliver items or products to the associated downstream entity. In a particular implementation of supply chain 100, however, a transportation path represented by a given arrowed line may not be used or assigned to actually transport any items. Accordingly, for a set of objectives, supply chain 100 may use all or part of the available transportation paths to deliver the items and products.

FIG. 2 illustrates an exemplary supply chain optimization system 200 (hereinafter referred to as “system 200”) consistent with certain disclosed embodiments. As shown in FIG. 2, system 200 may include one or more hardware and/or software components configured to display, collect, store, analyze, evaluate, distribute, report, process, record, and/or sort information related to logistics network management. System 200 may include one or more of a processor 210, a storage 220, a memory 230, an input/output (I/O) device 240, and a network interface 250. System 200 may be connected via network 260 to database 270 and supply chain 100, which may include one or more of supply chain entities, such as suppliers 110-113, manufacturing facilities 120-122, distributing facilities 130-133, and customers 140-144. That is, system 200 may be connected to computers or databases stored at one or more of the supply chain entities.

System 200 may be a server, client, mainframe, desktop, laptop, network computer, workstation, personal digital assistant (PDA), tablet PC, scanner, telephony device, pager, and the like. In one embodiment, system 200 may be a computer configured to receive and process information associated with different supply chain entities involved in supply chain 100, the information including purchasing orders, inventory data, and the like. In addition, one or more constituent components of system 200 may be co-located with any one of the supply chain entities.

Processor 210 may include one or more processing devices, such as one or more microprocessors from the Pentium™ or Xeon™ family manufactured by Intel™, the Turion™ family manufactured by AMD™, or any other type of processors. As shown in FIG. 2, processor 210 may be communicatively coupled to storage 220, memory 230, I/O device 240, and network interface 250. Processor 210 may be configured to execute computer program instructions to perform various processes and methods consistent with certain disclosed embodiments. In one exemplary embodiment, computer program instructions may be loaded into memory 230 for execution by processor 210.

Storage 220 may include a volatile or non-volatile, magnetic, semiconductor, tape, optical, removable, nonremovable, or other type of storage device or computer-readable medium. Storage 220 may store programs and/or other information that may be used by system 200.

Memory 230 may include one or more storage devices configured to store information used by system 200 to perform certain functions related to the disclosed embodiments. In one embodiment, memory 230 may include one or more modules (e.g., collections of one or more programs or subprograms) loaded from storage 220 or elsewhere that perform (i.e., that when executed by processor 210, enable processor 210 to perform) various procedures, operations, or processes consistent with the disclosed embodiment. For example, memory 230 may include an advanced forecasting module 231, a network modeling module 232, a facility design and management module 233, and a resource allocation module 234.

Advanced forecasting module 231 may generate forecast information related to one or more items at any one of the supply chain entities based on historical data associated with the item. For example, advanced forecasting module 231 may forecast or estimate a future demand for an item at each one of manufacturing facilities 120-122 and distributing facilities 130-133 based on respective historical demand data for that item at manufacturing facilities 120-122 and distributing facilities 130-133. Advanced forecasting module 231 may forecast or estimate future demands for an item at suppliers 110-113 by combining the forecasted demands for the item at each one of manufacturing facilities 120-122 and distributing facilities 130-133.

In addition, advanced forecasting module 231 may forecast or estimate the demand for a given item (e.g., a product) at each one of customers 140-144. Advanced forecasting module 231 may use a range of information to forecast or estimate the demands for the products, such as historical demand data at each customer, seasonal variations associated with a time period and the location of the customer, recent political or social events at the location of the customer, etc. Advanced forecasting module 231 may further determine a total network demand for the products based on the estimated demands at customers 140-144.

Network modeling module 232 may receive the forecasted information (e.g., the demands for an item) from advanced forecasting module 231 and simulate and optimize the flow of materials, parts, components, etc., between the supply chain entities and the structure of the supply chain network in order to meet certain business goals or objectives of the entire organization. The business goals or objectives may include at least one of response time, costs, profit, return on net assets, inventory turns, inventory level, service level, resilience of the supply chain network, environmental impact, total route distance, etc. Network modeling module 232 may simulate the flow of materials, parts, or components and optimize the structure of the supply chain network based on a number of parameters, such as geographical locations of each one of the supply chain entities, the transportation methods (e.g., air, ship, truck, etc.), the capacities of the transportation links (e.g., quantity of materials that can be transported via a certain route), and the manufacturing capacities of the manufacturing facilities. Based on the simulation results and other information, such as production costs, transportation costs, and regional sales prices, and the like, network modeling module 232 may generate information such as gross revenue, cost of goods sold, and profit related to one or more products or parts.

Network modeling module 232 may further generate an optimized network structure of the supply chain based on the parameters and information discussed above. The optimized network structure of the supply chain may specify, for example, the links or paths (i.e., represented by the arrowed line of FIG. 1) among the entities used to fill the demand for the item, the transportation methods used to transport materials and goods from one entity to another, the inventory level that should be maintained at each entity, etc.

Facility design and management module 233 may receive the forecasted information from advanced forecasting module 231 and the simulation results from network modeling module 232 and may determine the physical structure and dimension of one or more of manufacturing facilities 120-122 and distributing facilities 130-133 based on the received information. For example, facility design and management module 233 may receive forecasted information representing a quantity of the incoming items to be received at manufacturing facilities 120-122 and distributing facilities 130-133. Based on this forecasted information, facility design and management module 233 may determine dimensions and locations of shelving, racks, aisles, and the like, of manufacturing facilities 120-122 and distributing facilities 130-133. Facility design and management module 233 may also determine the location of incoming items within manufacturing facilities 120-122 and distributing facilities 130-133, based on the forecasted information. Moreover, facility design and management module 233 may simulate the movement of resources (e.g., workers, machines, transportation vehicles, etc.) throughout manufacturing facilities 120-122 and distributing facilities 130-133 over time. Still further, facility design and management module 233 may modify input information in order to achieve one or more of the desired business goals.

Resource allocation module 234 may receive availability data representing the quantity of one or more items that are available at suppliers 110-113. When the availability data is less than the forecasted demand data of the item at suppliers 110-113, resource allocation module 234 may allocate the available items at manufacturing facilities 120-122, distributing facilities 130-133, and customers 140-144 in order to achieve one or more of the business goals associated with the entire organization.

I/O device 240 may include one or more components configured to communicate information associated with system 200. For example, I/O device 240 may include a console with an integrated keyboard and mouse to allow a user to input parameters associated with system 200 and/or data associated with supply chain 100. I/O device 240 may include one or more display devices, such as monitors, or other peripheral devices, such as printers, cameras, microphones, speaker systems, electronic tablets, bar code readers, scanners, or any other suitable type of I/O device 240. System 200 may generate user interfaces through the display devices to provide optimization results to users. The user interfaces may include graphical elements and text that represent various aspects of the optimization results. System 200 may provide guidance, through the user interfaces, to assist the users to analyze and operate supply chain 100.

Network interface 250 may include one or more components configured to transmit and receive data via network 260, such as, for example, one or more modulators, demodulators, multiplexers, de-multiplexers, network communication devices, wireless devices, antennas, modems, and any other type of device configured to enable data communication via any suitable communication network. Network interface 250 may also be configured to provide remote connectivity between processor 210, storage 220, memory 230, I/O device 240, and/or database 270, to collect, analyze, and distribute data or information associated with supply chain 100 and supply chain optimization.

Network 260 may be any appropriate network allowing communication between or among one or more computing systems, such as, for example, the Internet, a local area network, a wide area network, a Wi-Fi network, a workstation peer-to-peer network, a direct link network, a wireless network, or any other suitable communication network. Connection with network 260 may be wired, wireless, or any combination thereof.

Database 270 may be one or more software and/or hardware components that store, organize, sort, filter, and/or arrange data used by system 200 and/or processor 210. Database 270 may store one or more tables, lists, or other data structures containing data associated with logistics network management. For example, database 270 may store operational data associated with each one of the supply chain entities, such as inbound and outbound orders, production schedules, production costs, and resources. The data stored in database 270 may be used by processor 210 to receive, categorize, prioritize, save, send, or otherwise manage data associated with logistics network management.

### INDUSTRIAL APPLICABILITY

The disclosed supply chain optimization system 200 may efficiently provide optimized supply chain network designs for any business organization to achieve one or more desired business goals or objectives. The network parameters of a supply chain may be adjusted by system 200 to generate a robust and efficient supply chain network design. In particular, the disclosed supply chain optimization system 200 may be implemented in a supply chain operated and configured by a business entity that manufactures and supplies a plurality of product lines to a plurality of customers.

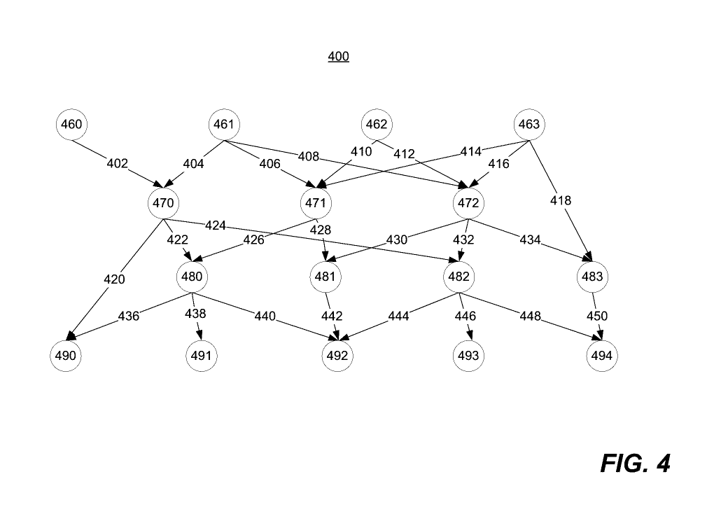

According to an embodiment, a supply chain may be configured based on a supply chain network model generated by system 200. FIG. 4 depicts an exemplary supply chain network model 400 that system 200 generates for supply chain 100. Supply chain network model 400 includes a plurality of nodes 460-463 representing the supply chain entities, such as suppliers 110-113. Supply chain network model 400 further includes a plurality of nodes 470-472 representing manufacturing facilities 120-122. Supply chain network model 400 further includes a plurality of nodes 480-483 representing distributing facilities 130-133. And supply chain network model 400 further includes a plurality of nodes 490-494 representing customers 140-144. Each node may have properties attached thereto to represent, for example, inventory volume, inventory cost, manufacturing capacity, or demands of the corresponding supply chain entity.

In addition, supply chain network model 400 may include a plurality of edges 402-450 corresponding to the arrowed lines connecting the supply chain entities of FIG. 1. The edges may represent, for example, flow of components, materials, or parts from one supply chain entity to another. Each edge includes an arrow indicating a direction of the flow. Each customer node is connected with at least one supply node by a plurality of edges that form one or more routes. For example, customer node 490 is connected with supply node 460 by edges 402 and 420 that form a first route. Customer node 490 is also connected with supply node 460 by edges 402, 422, and 436 that form a second route.

Each edge in supply chain network model 400 includes one or more properties, such as transportation volume, transportation time, transportation cost, tariff, energy price, environmental impact (e.g., carbon monoxide or other airborne emission), etc. Each property of an edge may be assigned a numerical value, which may be adjusted to optimize the supply chain model to achieve one or more given objectives.

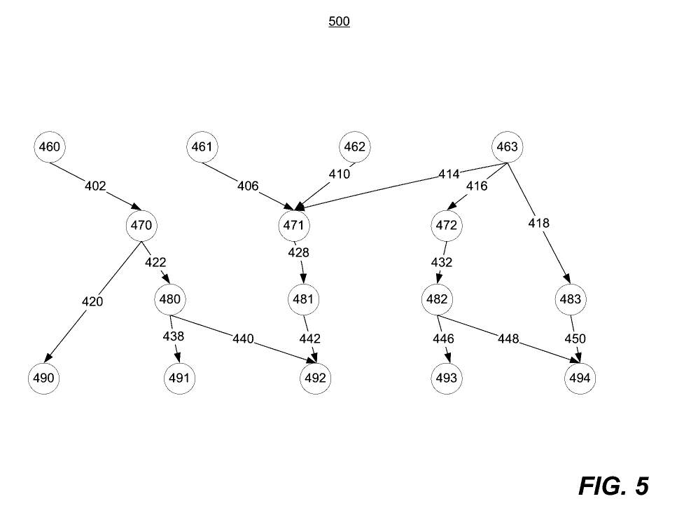

In an exemplary embodiment, system 200 may generate an optimized network structure or design for supply chain 100 using supply chain network model 400 and its network parameters, such as customer demands, transportation costs, inventory capacity, and the like. System 200 may use any known techniques, such as the ant colony method, the search tree method, or other linear or nonlinear optimization methods, to optimize the network structure for supply chain 100. FIG. 5 illustrates an exemplary optimized network structure 500 generated by system 200 for supply chain 100. Optimized network structure 500 may include only a portion of the edges indicating the transportation paths that will actually be used by supply chain 100 in the optimized implementation. The edges corresponding to those unused transportation paths are omitted in optimized network structure 500. For example, although customer 140 (corresponding to node 490) has the capability to receive products from distributing facility 130 (corresponding to node 480), an actual flow of products along this route does not provide an optimized solution. As result, optimized network structure 500 omits this path as indicated by the omission of edge 436 between nodes 480 and 490.

In another exemplary embodiment, an optimized network structure generated by system 200, although mathematically optimized, may be unduly sensitive to changes in network parameters or conditions. As a result, supply chain 100 that is configured based on such an optimized network structure may not be stable or robust, and may oscillate between different states, causing inefficiency and waste. The network parameters or conditions that may cause oscillation of supply chain 100 include, for example, customer demands for a product, or supplier demands for a material, a part, or an item, and the like. For example, optimized network structure 500 shown in FIG. 5 may be unduly sensitive to changes in customer demands at the customers represented by nodes 490-494. As a result, even a small change in the customer demands may cause undesired changes in the network structure.

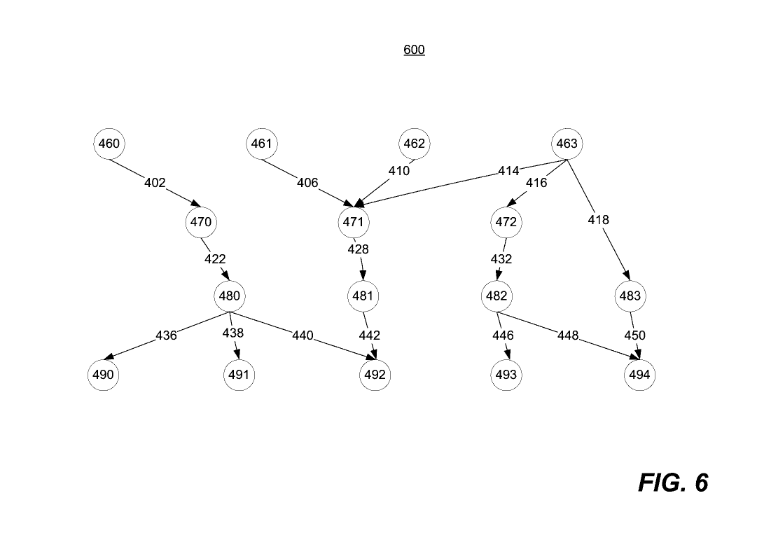

For example, according to optimized network structure 500, supply chain 100 is configured to deliver products from manufacturing facility 120 (represented by node 470) to customer 140 (represented by node 490) via a route represented by edge 420. When the customer demands increase or decrease by only a small amount, the network structure may change to a different network structure 600 shown in FIG. 6. Supply chain 100, configured according to network structure 600, changes to delivering products from distributing facility 130 (represented by node 480) to customer 140 (represented by node 490) via a path represented by edge 436. When there is an additional change in the customer demands, the network structure may change again. Similarly, an optimized network structure may also be sensitive to supplier demands at supplier 110-113 for a material, a part, or a component, such that when there is a slight fluctuation in the supplier demands, the supply network structure unexpectedly changes.

The oscillation, represented by the continuous, unexpected alteration in the network structure in response to demand changes is undesired during operation of supply chain 100. In particular, changing the configuration of a supply chain, such as a transportation path, generally incurs additional costs associated with, for example, moving equipment, setting up new facilities, acquiring new vehicle fleets, etc. In some instances, the optimized network structure may be so sensitive that it changes to a different structure whenever there is a fluctuation in customer demands, supplier demands, inventory levels, etc. In some other instances, the optimized network structure may be unduly sensitive even when the total network demand for a product is significantly below the total network capacity for supplying the product. Therefore, such a network structure is generally undesired for operation of supply chain 100, even it is optimized in the mathematical sense.

According to an embodiment, system 200 may detect potential oscillation in a supply chain during supply chain planning. Oscillation in a supply chain may be caused by geographical misalignment between the capacities to manufacture a product and the demands for the product on the market.

More specifically, as depicted in FIG. 1, the market for an underlying product, which supply chain 100 supplies to customers, includes three different geographical regions (i.e., region 1, region 2, and region 3). Manufacturing facilities 120 and 121 are located in geographical region 1, and manufacturing facility 122 is located in geographical region 2. Customers 140 and 141 are located in geographical region 1, customers 142 and 143 are located in geographical region 2, and customer 144 is located in geographical region 3.

It is further assumed that the production capacities of manufacturing facilities 120-122 for manufacturing the product are C1, C2, and C3, respectively, and the demands of customers 140-144 for the product are D1, D2, D3, D4, and D5, respectively. Oscillation occurs when the demand in any geographical region, such as D4 in region 3, exceeds the production capacity of any single manufacturing facility (i.e., any one of D1, D2, D3, D4, and D5). When this occurs, supply chain 100 must supply the product from at least two different manufacturing facilities in order to meet the demand in region 3, because none of the individual manufacturing facilities has sufficient capacity to supply the product to region 3.

In addition, because the manufacturing process and transportation from the manufacturing facilities to the customers cost time, when the demands in region 3 further change due to seasonality, supply chain 100 must respond by switching between different manufacturing facilities in an attempt to supply the product in a timely manner. The oscillation may be further worsened when supply chain 100 is used to supply more than one product line to the customers. Because of the competition between different product lines for network resources, the production capacities of the manufacturing facilities for an individual product are further limited or even completely eliminated. When there are changes in the customer demands for the individual product lines, oscillation in supply chain 100 mostly likely occurs, causing instability and waste. Although oscillation may be mitigated by increasing inventory levels at the manufacturing facilities and the distributing facilities, inventory may incur substantial carrying costs and risks, and is generally disfavored by business.

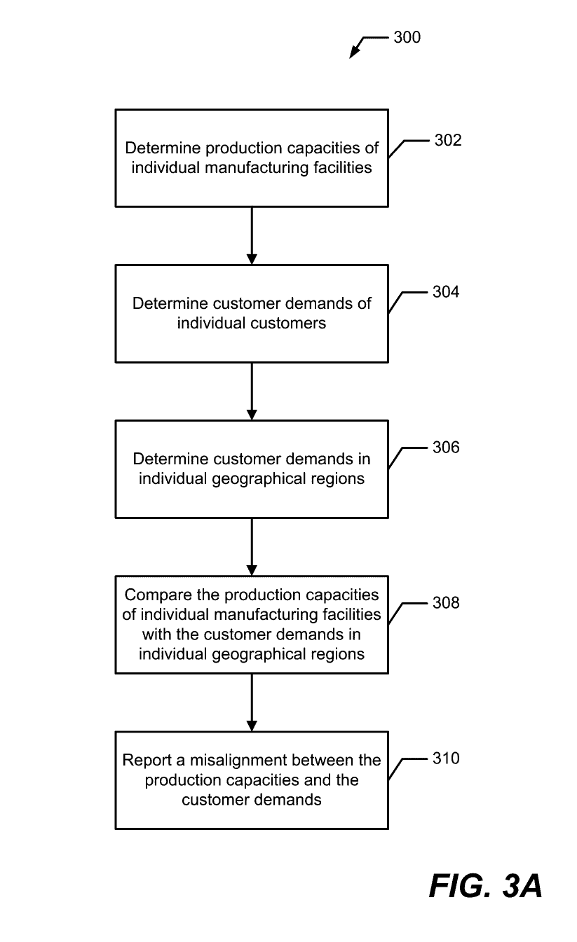

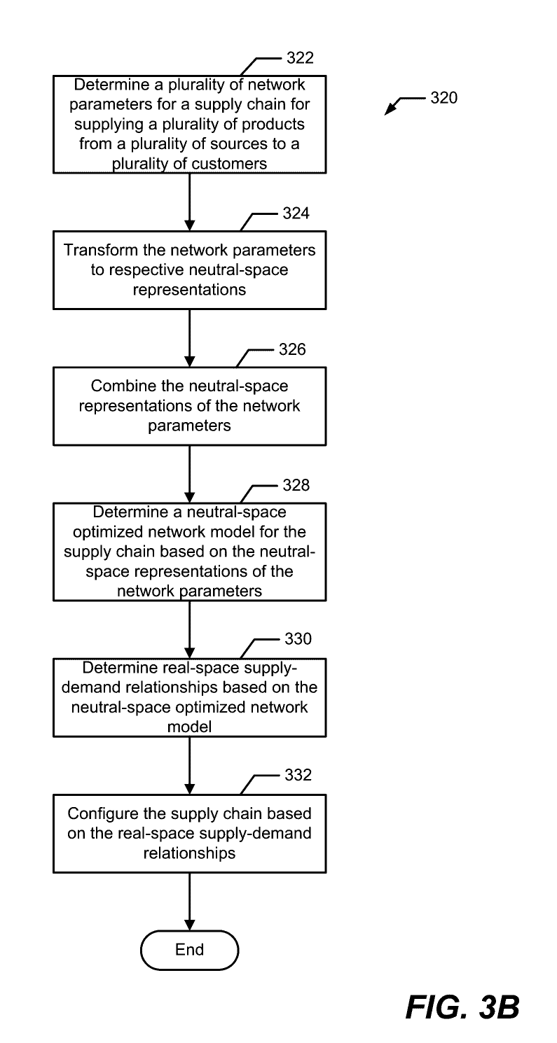

In an embodiment, system 200 may be configured to detect the geographical misalignment between production capacities and demands that causes the oscillation. FIG. 3A depicts an exemplary process 300 that may be implemented in system 200 for detecting geographical misalignment between the production capacities and the customer demands, according to an embodiment. According to process 300, at step 302, system 200 may first determine the production capacities C1-C3 of individual manufacturing facilities 120-122. The production capacities C1-C3 may be determined based on data collected from manufacturing facilities 120-122 through network 260. System 200 may include communications interfaces for manufacturing facilities 120-122 to provide data indicating the production capacities for individual product lines.

At step 304, system 200 may further determine the demands D1-D5 of individual customers 140-144. The customer demands D1-D5 may be determined for a particular time period according to known techniques based on information, such as orders received from the customers for the current time period, demand for the products in a prior time period, demand for the products in similar time periods (i.e., the same time period of prior years, months, etc.), seasonal variations, recent political events that may affect demands, and the like.

At step 306, system 200 may determine the customer demands in the individual geographical regions 1-3. For example, the demand in region 1 is the total of demands D1 and D2, the demand in region 2 is the total of demands D3 and D4, and the demand in region 3 is the demand D4.

At step 308, system 200 may compare the production capacities C1-C3 of individual manufacturing facilities 120-122 with the customer demands in the individual geographical regions 1-3. Based on the comparison, system 200 may determine whether the customer demand in any one of the geographical regions 1-3 is greater than the capacity of any one of the manufacturing facilities 120-122.

At step 310, system 200 may then report the comparison results through I/O device 240 or a graphical user interface generated by processor 210. System 200 may also store the comparison results in storage 220 or database 270. The comparison results may indicate to a user whether there is a misalignment between the production capacities and the customer demands. Alternatively, the comparison results may also indicate which geographical region, if any, has customer demand that exceeds the production capacity of any one of manufacturing facilities 120-122. Still alternatively, the comparison results may also indicate which manufacturing facility, if any, has production capacity that is below the customer demand of any one of the individual regions 1-3.

In another embodiment, if supply chain 100 supplies multiple product lines, system 200 may carry out process 300 for each of the product lines to determine whether oscillation may occur during operation of supply chain 100.

According to an exemplary embodiment, system 200 may generate an optimized supply chain network structure that is stable and robust, and configure supply chain 100 according to the optimized supply chain network structure to reduce or even eliminate oscillation described above. In general, rather than managing the customer demands or increasing inventory levels to reduce oscillation, system 200 may manage the production capacities by adjusting or resetting the production capacities C1-C3 of manufacturing facilities 120-122 according to the customer demands D1-D5 of customers 140-144. System 200 may adjust the production capacities by considering the multiple product lines simultaneously supplied by supply chain 100. More particularly, system 200 may transform the network parameters of supply chain 100 from a real space to a neutral space for all product lines, generate the optimized supply chain network structure based on neutral-space representations of the network parameters, and transform the optimized supply chain network structure back to the real space to configure the supply chain.

The term “real space” here refers to a collection of representations (i.e., real-space representations) of network parameters indicating how the supply chain handles different product lines at different network entities in a real-life situation. For example, in the real space, the production capacity at a manufacturing facility for a product may be represented in “unit,” “ton,” “cubic meter,” or the like. The production rate for the product line at the manufacturing facility may be represented in “unit per day,” “ton per day,” “cubic meter per day,” or the like. The costs for manufacturing each unit of the product at the manufacturing facility may be represented in “dollar per unit,” “dollar per ton,” “dollar per cubic meter,” or the like. The costs for transporting the product may be represented in “dollar per unit,” “dollar per ton,” “dollar per cubic meter,” or the like. Because each product has a different basis for manufacturing and transportation, each product may be represented differently depending on how it is handled in the real-life situation.

The term “neutral space” here refers to a collection of representations (i.e., neutral-space representations) of the network parameters that provide a common basis for comparison across different products at different network entities. The neutral-space representations may be unit-less or unit-neutral. For example, the neutral-space representations of the network parameters may be normalized so that the network parameters are unit-less. Alternatively, the neutral-space representations of the network parameters may be represented according to any one of the real-space representations, such as “per unit,” “per ton,” “per unit spatial volume,” or the like. The “per unit spatial volume” may be, for example, “per cubic meter,” “per cubic inch,” “per cubic foot,” or the like. Still alternatively, the neutral-space representations of the network parameters may be represented according to a user-set format, as long as the user-set format provides a common basis for comparisons between different product lines and different network entities.

The following exemplary embodiments are described using the “per cubic meter” basis as the neutral-space representations. In addition, it is assumed that supply chain 100 in the following exemplary embodiments is configured to supply two different lines of products, product A and product B, from manufacturing facilities 120-122 to customers 140-144. However, persons of ordinary skill in the art would appreciate that other neutral-space representations as well as any numbers of product lines may be adopted in these exemplary embodiments without departure from the principle of the disclosure.

FIG. 3B illustrates a flow chart of an exemplary process 320 that may be implemented in system 200 for reducing or eliminating oscillation in a supply chain, consistent with a disclosed embodiment. According to process 300, at step 322, processor 210 of system 200 may determine network parameters for supply chain 100. The network parameters may include, for example, customer demands for each of the products A and B at customers 140-144, supplier demands for a material, a part, or a component at suppliers 110-113, production rates at manufacturing facilities 120-122 for producing products A and B, inventory levels at distribution facilities 130-133 for products A and B, costs of transporting products A and B using respective transportation paths, or demands/capacities/costs/prices at any other network entities for supplying products A and B.

The network parameters maybe determined by system 200 using any known techniques. For example, the customer demands for products A and B at customers 140-144 during a particular time period may be determined according to known techniques based on information, such as orders received from the customers for the current time period, demand for the products in a prior time period, demand for the products in similar time periods (i.e., the same time period of prior years, months, etc.), seasonal variations, recent political events that may affect demands, and the like. As another example, the production costs for products A and B at manufacturing facilities 120-122 may be determined based on data collected from each manufacturing facility, such as numbers of production lines, the production rate of each production line, numbers of workers, and the like.

At step 324, processor 210 transforms the network parameters from the respective real-space representations in the real space to the respective neutral-space representations in the neutral space (i.e., the “per cubic meter” space). In one embodiment, processor 210 may first select a proper neutral space from those discussed above, according to a user input or a preset configuration of the system. The transformation may be carried out from the real space to the selected neutral space for each product line, network entity, and transportation path.

For example, the production capacities for products A and B at each manufacturing facility are transformed from “unit” to “cubic meter.” Similarly, the demands for products A and B at each customer are transformed from “unit” to “cubic meter.” The costs for manufacturing products A and B at each manufacturing facility are transformed from “dollar per unit” to “dollar per cubic meter.” The costs for transporting products A and B by each transportation path are “dollar per cubic meter” in real space and, thus, remain unchanged in the neutral space. Other network parameters may be similarly transformed into the “per cubic meter” neutral space.

In order to calculate the neutral-space representations for the network parameters, processor 210 may query database 270 or storage 220, for the transformation relationship between the real space and the neutral space. In an embodiment, processor 210 may receive data entries indicating the transformation relationships for network parameters, such as production capacities, demands, costs of manufacturing, and the like. For example, the data entries provided by the query may include data about the corresponding relationship between each unit of a product and the volume (in cubic meter) of each product. Using these transformation relationships, processor 210 may calculate the neutral-space representations for the network parameters for products A and B and for all network entities and transportation paths.

At step 326, system 200 combines the neutral-space representations of the same network parameters across all products A and B. For example, system 200 combines the neutral-space representations of the customer demands for products A and B at each of customers 140-144. System 200 also combines the neutral-space representations of the transportation costs for products A and B along each transportation path. System 200 also combines the neutral-space representations of the inventor levels for products A and B at each of distributing facilities 130-133. By transforming the network parameters to the neutral space and combining the neutral-space representations, system 200 removes the identities of the products A and B. More particularly, since all network parameters are represented on the “per cubic meter” basis in the neutral space, product A and product B are no longer distinguishable in terms of manufacturing costs, production capacities, transportation costs, demands, inventory, and the like. As a result, the combined neutral-space representations of the network parameters represent information of supply chain 100 that supplies a neutral “object” or “thing” (i.e., the neutral-space product).

At step 328, processor 210 determines a neutral-space optimized network model for supply chain 100 based on the combined neutral-space representations of the network parameters. The neutral-space optimized network model may be determined using any known techniques, such as the colony ant algorithm, the search tree method, or other linear and non-linear optimization techniques. During the optimization, the neutral-space customer demands remain unchanged, while the production capacities of the manufacturing facilities and the network structure are adjusted. The neutral-space optimized network model may be represented by a neutral-space optimized supply chain network structure, similar to those shown in FIGS. 5 and 6.

In addition, since the optimization is carried out in the neutral space, parameters of the neutral-space optimized network model are also specified in the neutral space. For example, in the neutral-space optimized network model, the optimized production capacity at a manufacturing facility, the optimized inventory level at each network entity, and the optimized transportation volume along a transportation path are specified on the “per cubic meter” basis.

At step 330, processor 210 may determine real-space supply-demand relationships based on the neutral-space optimized network model. The real-space supply-demand relationships indicate how products A and B are supplied in the real space from manufacturing facilities 120-122 to customers 140-144.

More particularly, processor 210 first determines neutral-space supply-demand relationships based on the neutral-space optimized network model determined at step 328. The neutral-space supply-demand relationships may be provided as part of the results of optimizing the supply chain network structure and may be represented by a table similar to Table I shown below:

TABLE I
(All Values Are In “Cubic Meters”)

| | Manufacturing | Manufacturing Facility | Manufacturing |
|---|---|---|---|
| | Facility 120 | 121 | Facility 122 |
| Customer 140 | 200 | 0 | 0 |
| Customer 141 | 50 | 0 | 0 |
| Customer 142 | 100 | 200 | 0 |
| Customer 143 | 0 | 0 | 300 |
| Customer 144 | 0 | 0 | 250 |

In Table I, each cell corresponds to one of manufacturing facilities 120-122 and one of customers 140-144. The value in each cell represents an amount of neutral-space products supplied by the corresponding manufacturing facility to the corresponding customer. For example, manufacturing facility 120 supplied 200 cubic meters of neutral-space products to customer 140, 50 cubic meters of neutral-space products to customer 141, 100 cubic meters of neutral-space products to customer 142, and no products to customers 143, and 144. Manufacturing facility 121 supplies 200 cubic meters of neutral-space products to customer 142 and no products to customers 140, 141, 143, and 144. Similarly, manufacturing facility 122 supplies 300 cubic meters of neutral-space products to customer 143, 250 cubic meters of neutral-space products to customer 144, and no products to customers 140-142.

Since the identities of products A and B are removed in neutral-space, Table I provides a mapping that indicates, optimally, how supply chain 100 should supply the neutral-space products from manufacturing facilities to customers without considering differences between the product lines. Table I also indicates the optimal product capacity that each manufacturing facility should have in order to satisfy the customer demands regardless of product lines. For example, the optimal production capacity of manufacturing facility 120 is 350 (i.e., 200+50+100) cubic meters, the optimal production capacity of manufacturing facility 121 is 200 cubic meters, and the optimal production capacity of manufacturing facility 122 is 550 (i.e., 300+250) cubic meters.

Processor 210 may then transform the neutral-space supply-demand relationship shown in Table I to the real-space supply-demand relationship. Specifically, processor 210 may refer to the real-space customer demands of each customer and apportion neutral-space customer demands accordingly. For example, it is assumed that customer 140 demands 5 units of product A and 5 units of product B. It is further assumed that product A is 10 cubic meters per unit and that product B is 30 cubic meters per unit. Accordingly, the neutral-space customer demands of customer 140 are divided into 50 cubic meters assigned to product A and 150 cubic meters assigned product B. Since customer 140 receives all of the neutral-space products from manufacturing facility 120, according to the neutral-space supply-demand relationship in Table I, manufacturing facility 120 is configured to provide customer 140 with 5 units of product A and 5 units of product B.

Similarly, it is assumed that customer 141 demands 5 units of product A and no product B. The neutral-space customer demands of customer 141 are all assigned to product A. Similarly to customer 140, since customer 141 receives all neutral-space products from manufacturing facility 120 according to Table I, manufacturing facility 120 is configured to provide customer 140 with 5 units of product A and no product B.

For customer 142, it is assumed that it demands 12 units of product A and 6 units of product B. According to Table I, customer 142 receives neutral-space products from both manufacturing facility 120 and manufacturing facility 121. Processor 210 may attempt to first use the manufacturing facility that provides the greater amount of neutral-space products, which is manufacturing facility 121 in this case, to satisfy the customer demands of customer 142. When all of the neutral-space manufacturing capacity of manufacturing facility 121 is used, processor 210 may then use the manufacturing facility that provides the fewer amounts of neutral-space products, which is manufacturing facility 120 in this case. In addition, processor 210 may assign the product with the greater profit margin to the manufacturing facility that provides the greater amounts of neutral-space products.

Referring to Table I, it is assumed that product B offers a greater profit margin than product A. Accordingly, processor 210 may first use the 200 cubic meters of neutral-space products provided by manufacturing facility 121 to satisfy the demands for 6 units of product B at customer 142. As a result, the remaining 20 (i.e., 200−6×30=20) cubic meters of neutral-space products provided by manufacturing facility 121 are assigned to product A. Thus, manufacturing facility 121 is configured to provide 2 units of product A and 6 units of product B to customer 142.

In addition, the 100 cubic meters of neutral-space products provided by manufacturing facility 120 are all assigned to meet the remaining demands for 10 units of product A at customer 142. Accordingly, manufacturing facility 120 is configured to provide 10 units of product A and no product B to customer 142.

For customer 143, it is assumed that it demands no product A and 10 units of product B. Accordingly, the neutral-space demands of customer 143 are all assigned to product B. Since customer 143 receives all neutral-space products from manufacturing facility 122 according to Table I, manufacturing facility 122 is configured to supply customer 143 with no product A and 10 units of product B.

For customer 144, it is assumed that it demands 4 units of product A and 7 units of product B. Accordingly, the neutral-space customer demands of customer 144 are divided into 40 cubic meters for product A and 210 cubic meters for product B. Since customer 144 receives all neutral-space products from manufacturing facility 122 according to Table I, manufacturing facility 122 is configured to supply customer 144 with 4 units of product A and 7 units of product B.

When all of the neutral-space customer demands are apportioned and assigned to product A and product B, the neutral-space supply-demand relationships are transformed back to the real space. Table II below shows an example of real-space supply-demand relationships determined based on the neutral-space supply-demand relationships in Table I.

TABLE II
(All Values Are In “Units”)

| | Manufacturing | Manufacturing Facility | Manufacturing |
|---|---|---|---|
| | Facility 120 | 121 | Facility 122 |
| Customer 140 | 5 As, 5 Bs | 0 | 0 |
| Customer 141 | 5 As, 0 B | 0 | 0 |
| Customer 142 | 10 As, 0B | 2 As, 6 Bs | 0 |
| Customer 143 | 0 | 0 | 0 A, 10 Bs |
| Customer 144 | 0 | 0 | 4 As, 7 Bs |
| Capacity | 20 As, 5 Bs | 2 As, 6 Bs | 4 As, 17 Bs |

At step 332, processor 210 configures supply chain 100 based on the real-space supply-demand relationships shown in Table II. First, processor 210 determines the optimal real-space production capacities by summing all of the real-space demands that are assigned to each manufacturing facility. Referring to Table II, processor 210 sums all of the demands for product A and product B listed in the first column. As a result, the optimal production capacity at manufacturing facility 120 is 20 units of product A and 5 units of product B. Similarly, the optimal production capacity at manufacturing facility 121 is 2 units of product A and 6 units of product B. The optimal production capacity at manufacturing facility 122 is 4 units of product A and 17 units of product B. Thereafter, processor 210 may then configure or reset supply chain 100 according to the optimal production capacities determined above.

According to a further embodiment, processor 210 may also compare the performance of the neutral-space optimization technique disclosed here with the performance of conventional techniques. For example, processor 210 may determine an optimized supply chain network structure using the conventional optimization techniques and determine supply-demand relationships based on the conventionally-optimized supply chain network model. Table III below shows an example of the conventionally-optimized supply-demand relationships between manufacturing facilities 120-122 and customers 140-144.

TABLE III
(All Values Are In “Units”)

| | Manufacturing | Manufacturing Facility | Manufacturing |
|---|---|---|---|
| | Facility 120 | 121 | Facility 122 |
| Customer 140 | 5 As, 0 B | 0 A, 5 Bs | 0 |
| Customer 141 | 5 As, 0 B | 0 | 0 |
| Customer 142 | 12 As, 0 B | 0 As, 6 Bs | 0 |
| Customer 143 | 0 | 0 | 0 A, 10 Bs |
| Customer 144 | 4 As, 0 B | 0 | 0 As, 7 Bs |
| Capacity | 26 As, 0 B | 0 As, 11 Bs | 0 As, 17 Bs |

As shown in Table III above, conventional optimization techniques tend to configure each manufacturing facility to provide one product line exclusively, because the individual manufacturing facility generally operates more efficiently if only one product line is produced. Such configurations, however, are usually sub-optimal when more than one product line is demanded. In particular, a supply chain configured according to the supply-demand relationships in Table III is almost bound to have oscillation due to the geographical misalignment between the production capacities and customer demands. As discussed above, oscillation may cause inefficiency and waste during the operation of the supply chain. As a result, optimal production capacities for individual manufacturing facilities do not generally provide an optimal supply chain network model in terms of overall performance, such as overall profits and stability, for multiple product lines.

A comparison between Table II and Table III shows that although each of the manufacturing facilities is configured to produce more than one product according to the disclosed neutral-space optimization technique, the overall profits and stability of the supply chain are improved. Oscillation in the neutral-space optimized network model is substantially reduced.

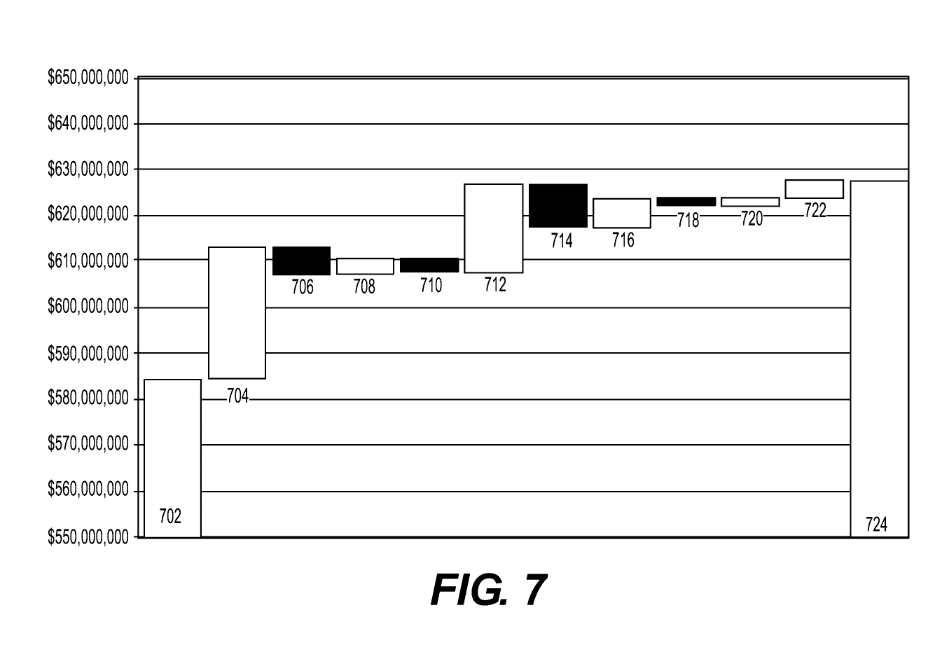

FIG. 7 illustrates an exemplary interface 700 generated by system 200 that presents a comparison of performance between a conventionally optimized supply chain and an exemplary embodiment consistent with this disclosure. The supply chain used to obtain the results in FIG. 7 provides 10 different product lines globally. When optimized using conventional techniques, the supply chain generates $584 million in overall gross profit (represented by bar 702). In contrast, when optimized using the neutral-space optimization technique disclosed here, the supply chain generates $628 in overall gross profit (represented by bar 724).

Bars 704-722 in FIG. 7 represent changes in profits for individual product lines after the supply chain is optimized using the disclosed neutral-space optimization technique, in comparison with profits when optimized using the conventional techniques. Bars 704, 708, 712, 716, 720, and 722 in white represent increases in profits for corresponding product lines, and bars 706, 710, 714, and 718 in black represent decreases in profits for corresponding product lines. As shown in FIG. 7, although profits for some product lines decreases after the supply chain is optimized using the neutral-space optimization technique, the overall gross profit still increases by about 3%.

As further shown in Tables I and II above, even in the neutral-space optimized supply chain network model, customer 142 still receives products from two different manufacturing facilities (i.e., manufacturing facilities 120 and 121), causing potential oscillation. However, this may be a result of a preference by the customer who insists on receiving products from different manufacturing facilities. Nevertheless, the neutral-space optimization may still reduce or minimize such oscillation by configuring both manufacturing facilities 120 and 121 to provide product A to customer 142. In addition, the neutral-space products in Table I allow the amount of products supplied by manufacturing facility 120 and that supplied by manufacturing facility 121 on a common basis (i.e., the “per cubic meter” basis) so as to more accurately assess the economic impacts when oscillation occurs in the supply chain.

It will be apparent to those skilled in the art that various modifications and variations can be made to the disclosed supply chain optimization system. Other embodiments will be apparent to those skilled in the art from consideration of the specification and practice of the disclosed supply chain optimization system. It is intended that the specification and examples be considered as exemplary only, with a true scope being indicated by the following claims and their equivalents.

What is claimed is:

1. A system for reducing oscillation in a supply chain including a plurality of supply chain entities, the supply chain entities including a plurality of sources and a plurality of customers, the system comprising:
a memory configured to store instructions;
one or more input/output devices configured to receive user inputs and generate a user interface; and
a processor configured to receive the instructions from the memory and execute the instructions, the instructions causing the processor to:
determine a plurality of network parameters for the supply chain for supplying a plurality of product lines from the plurality of sources to the plurality of customers;
transform the network parameters from a real space to a neutral space according to a common basis;
determine a neutral-space optimized network model for the supply chain based on neutral-space representations of the network parameters;
determine real-space supply-demand relationships based on the neutral-space optimized network model; and
configure the supply chain based on the real-space supply-demand relationships.

2. The system of claim 1, wherein the instructions further cause the processor to:
determine production capacities based on the real-space supply-demand relationships; and
configure the sources according to the determined production capacities.

3. The system of claim 1, wherein the instructions further cause the processor to combine the neutral-space representations of the network parameters across different product lines.

4. The system of claim 1, wherein the instructions further cause the processor to compare performance of the supply chain configured based on the neutral-space optimized network model and performance of the supply chain configured based on a conventional technique.

5. The system of claim 1, wherein the common basis is per unit spatial volume.

6. The system of claim 1, wherein the instructions further cause the processor to determine neutral-space supply-demand relationships based on the neutral-space optimized network model, the neutral-space supply-demand relationships indicating an amount of neutral-space products provided by each source to each customer.

7. The system of claim 6, wherein the instructions further cause the processor to determine the real-space supply-demand relationships by apportioning the amount of neutral-space products provided by each of the sources according to real-space customer demands for the plurality of product lines.

8. A method for reducing oscillation in a supply chain including a plurality of supply chain entities, the supply chain entities including a plurality of sources and a plurality of customers, the method comprising:
determining, by a processor, a plurality of network parameters for the supply chain for supplying a plurality of product lines from the plurality of sources to the plurality of customers;
transforming, by the processor, the network parameters from a real space to a neutral space according to a common basis;
determining, by the processor, a neutral-space optimized network model for the supply chain based on neutral-space representations of the network parameters;
determining, by the processor, real-space supply-demand relationships based on the neutral-space optimized network model; and
configuring, by the processor, the supply chain based on the real-space supply-demand relationships.

9. The method of claim 8, wherein the configuring the supply chain based on the real-space supply-demand relationships further comprises:
determining production capacities based on the real-space supply-demand relationships; and
configuring the sources according to the determined production capacities.

10. The method of claim 8, wherein the transforming the network parameters from a real space to a neutral space according to a common basis further comprises combining the neutral-space representations of the network parameters across different product lines.

11. The method of claim 8, further comprising comparing performance of the supply chain configured based on the neutral-space optimized network model and performance of the supply chain configured based on a conventional technique.

12. The method of claim 8, wherein the common basis is per unit spatial volume.

13. The method of claim 8, wherein the determining real-space supply-demand relationships based on the neutral-space optimized network model further comprises:
determining neutral-space supply-demand relationships based on the neutral-space optimized network model, the neutral-space supply-demand relationships indicating an amount of neutral-space products provided by each source to each customer.

14. The method of claim 13, further comprising apportioning the amount of neutral-space products provided by each of the sources according to real-space customer demands for the plurality of product lines.

15. The method of claim 8, further comprising detecting a potential for oscillation in the supply chain by comparing the production capacities with the customer demands.

16. A non-transitory computer-readable medium including instructions, which, when executed by one or more processors, cause the one or more processors to perform a method for reducing oscillation in a supply chain including a plurality of supply chain entities, the supply chain entities including a plurality of sources and a plurality of customers, the method comprising:
determining a plurality of network parameters for the supply chain for supplying a plurality of product lines from the plurality of sources to the plurality of customers;
transforming the network parameters from a real space to a neutral space according to a common basis;
determining a neutral-space optimized network model for the supply chain based on neutral-space representations of the network parameters;
determining real-space supply-demand relationships based on the neutral-space optimized network model; and
configuring the supply chain based on the real-space supply-demand relationships.

17. The computer-readable medium of claim 16, wherein the instructions further cause the one or more processors to:
determine production capacities based on the real-space supply-demand relationships; and
configure the sources according to the determined production capacities.

18. The computer-readable medium of claim 16, wherein the instructions further cause the one or more processors to combine the neutral-space representations of the network parameters across different product lines.

19. The computer-readable medium of claim 16, wherein the instructions further cause the one or more processors to compare performance of the supply chain configured based on the neutral-space optimized network model and performance of the supply chain configured based on a conventional technique.

20. The computer-readable medium of claim 16, wherein the common basis is per cubic meter.
